(19) United States
(12) Patent Application Publication
(10) Pub. No.: US 2003/0131928 A1
(43) Pub. Date: Jul. 17, 2003

(54) Blind slat extruding method at room temperature

(76) Inventor: Ming Nien, Changhua Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 10/046,210

(22) Filed: Jan. 16, 2002

(51) Int. Cl. B29C 47/00

(52) U.S. Cl. 156/244.12

(57) ABSTRACT

A room temperature blind slats extruding method includes the steps of (a) cutting wooden material into wooden plates and then delivering the wooden plates to the extruding mold of an extruding machine after washed, (b) preparing a liquid coating mixture containing Methyl Cellulose, water, Calcium Carbonate, and glue, and then delivering the liquid coating mixture to the extruding mold of the extruding machine, (c) ejecting the liquid coating mixture through an extruding nozzle to the wooden plates, enabling the wooden plates to be respectively covered with a uniform layer of the liquid coating mixture, and (d) drying the coated wooden plates into finished blind slats.

### FIELD OF THE INVENTION

The present invention relates to a blind slat fabrication method and, more particularly, to a room temperature blind slat extruding method.

### BACKGROUND OF THE INVENTION

Regular blind slats for Venetian blinds are commonly comprised of a wooden core and a plastic cover layer covered on the outside wall of the wooden core. The wooden core protects the slat against deformation due to the effect of ambient temperature. The plastic cover layer protects the slat against deformation due to the effect of ambient moisture.

FIG. 1 shows the fabrication of this design of blind slats. According to this blind slat fabrication method, wooden material 2 is prepared and then properly cut into wooden plates 2a subject to the desired size, and then the wooden plates 2a are well cleaned 2b and then delivered 2c to the extruding mold of an extruding machine for extrusion 4. At the same time, coating materials 3 are prepared, and then mixed into liquid mixture 3a, and then heated 3b in the extruding machine, and then delivered to the extruding mold of the extruding machine for extrusion 4. During extrusion 4, each wooden plate 2a is coated with the liquid mixture 3a, and then dried 5. When dried, the desired blind slats 1 are obtained. According to this blind slat fabrication method, prepared liquid mixture 3a must be heated 3b in the extruding machine before extruding with the prepared wooden plate. Working under a high temperature environment is not good to workers in the production line. The high-temperature working requirement causes the machine to wear quickly with use, and greatly increases the manufacturing cost of the blind slats. Furthermore, the effect of heat deteriorates the structural strength of the wooden plates.

### SUMMARY OF THE INVENTION

The present invention has been accomplished to provide a room temperature blind slat extruding method, which eliminates the aforesaid drawbacks.

It is one object of the present invention to provide a room temperature blind slat extruding method, which improves the working quality in the production line.

According to the present invention, the room temperature blind slats extruding method includes the steps of (a) cutting wooden material into wooden plates and then delivering the wooden plates to the extruding mold of an extruding machine after washed, (b) preparing a liquid coating mixture containing Methyl Cellulose, water, Calcium Carbonate, and glue, and then delivering the liquid coating mixture to the extruding mold of the extruding machine, (c) ejecting the liquid coating mixture through an extruding nozzle to the wooden plates, enabling the wooden plates to be respectively covered with a uniform layer of the liquid coating mixture, and (d) drying the coated wooden plates into finished blind slats. Because materials are extruded into finished blind slats at room temperature, no heating apparatus is used, and much equipment installation cost is saved.

### BRIEF DESCRIPTION OF THE DRAWINGS

FIG. 1 is a block diagram explaining a blind slat fabrication flow according to the prior art.

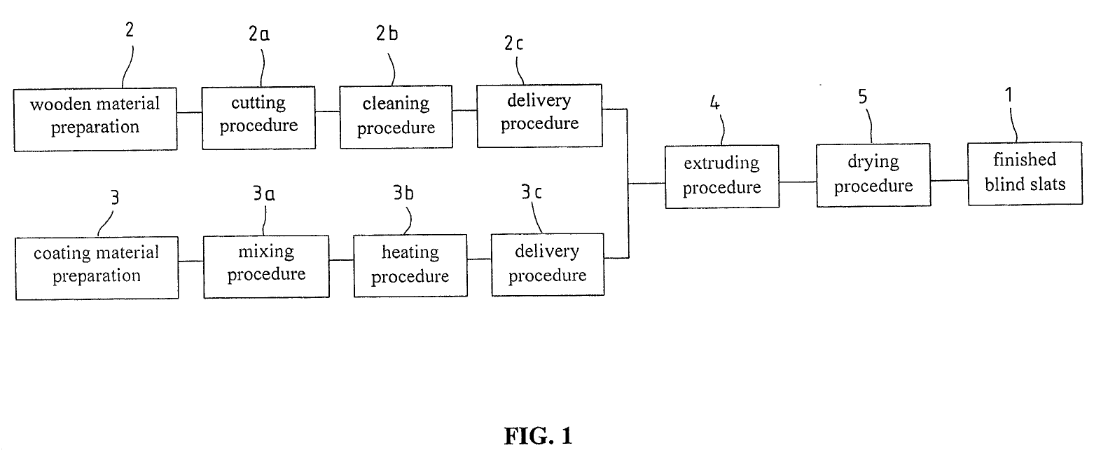

FIG. 2 is a block diagram explaining a room temperature blind slat extruding method according to the present invention.

### DETAILED DESCRIPTION OF THE INVENTION

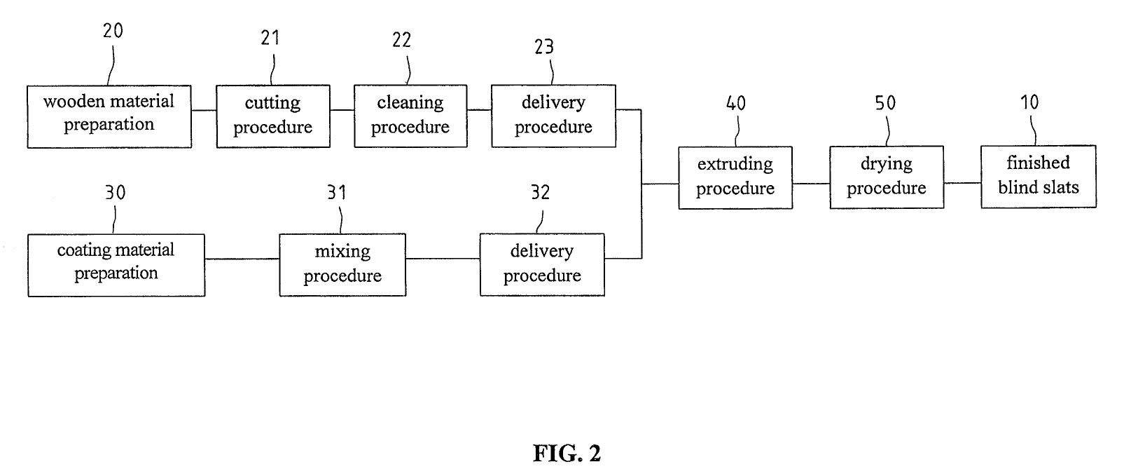

Referring to FIG. 2, a room temperature blind slat extruding method for making blind slats 10 in accordance with the present invention comprises the steps of:

I. Wooden material preparation 20:

(i) Cutting procedure 21, where selected wooden material is cut into wooden plates subject to the desired size;

(ii) Cleaning procedure 22, where the wooden plates thus obtained are well cleaned and trimmed;

(iii) Delivery procedure 23, where the well cleaned wooden plates are delivered to the extruding mold of an extruding machine.

II. Coating material preparation 30:

(i) Material mixing procedure 31, where a liquid coating mixture is prepared in a mixer, which liquid coating mixture containing, for example, MC (Methyl Cellulose) 0.5˜1.0 kg, water 8.5˜1.6 kgs, Calcium Carbonate 16˜30 kgs, wood glue 2.5˜5 kgs, and thickener 2.5˜5 kgs. The ratio by weight of the ingredients is about 0.2:3.3:6:1:1;

(ii) Delivery procedure 32, where the prepared liquid coating mixture is delivered from the mixer through a delivery pipe to the extruding mold of the extruding machine;

III. Extruding process 40:

Where the liquid coating mixture is ejected through an extruding nozzle to the wooden plates, enabling the wooden plates to be respectively covered with a uniform layer of the liquid coating mixture;

IV. Drying process 50:

Where the coated wooden plates are well dried, forming the desired blind slats.

According to the aforesaid blind slat fabrication method, the invention achieves the following advantages:

1. Low manufacturing cost: Because materials are extruded into finished blind slats at room temperature, no heating apparatus is used, and much equipment installation cost is saved.

2. High manufacturing efficiency: Because the invention eliminates the conventional material heating procedure, much heating time is saved, and the final drying time is greatly shortened.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A room temperature blind slats extruding method comprising the steps of:
(a) cutting wooden material into wooden plates subject to the desired size, and then well cleaning and trimming the wooden plates, and then delivering said wooden plates to the extruding mold of an extruding machine;
(b) preparing a liquid coating mixture containing MC (Methyl Cellulose), water, Calcium Carbonate, and glue, and then the prepared liquid coating mixture is delivered to the extruding mold of the extruding machine to which the prepared wooden plates are delivered;
(c) ejecting the liquid coating mixture through an extruding nozzle to the wooden plates, enabling the wooden plates to be respectively covered with a uniform layer of the liquid coating mixture; and
(d) drying the coated wooden plates, thus forming the desired blind slats.

2. The room temperature blind slats extruding method as claimed in claim 1, wherein the ratio by weight of the ingredients of MC (Methyl Cellulose), water, Calcium Carbonate, and glue is about 0.2:3.3:6:2.

3. The room temperature blind slats extruding method as claimed in claim 1, wherein said glue contains 50% by weight of wood glue and 50% by weight of thickener.

4. The room temperature blind slats extruding method as claimed in claim 2 wherein said glue contains 50% by weight of wood glue and 50% by weight of thickener.
